(19) United States
(12) Patent Application Publication
(10) Pub. No.: US 2025/0055060 A1
(43) Pub. Date: Feb. 13, 2025

(54) BATTERY MODULE

(71) Applicant: TOYOTA JIDOSHA KABUSHIKI KAISHA, Toyota-shi (JP)

(72) Inventors: Masataka OGUSHI, Nisshin-shi (JP); Masaya NAKAMURA, Kariya-shi (JP)

(73) Assignee: TOYOTA JIDOSHA KABUSHIKI KAISHA, Toyota-shi (JP)

(21) Appl. No.: 18/773,752

(22) Filed: Jul. 16, 2024

(30) Foreign Application Priority Data
Aug. 10, 2023 (JP) 2023-131155

(51) Int. Cl. H01M 10/653; H01M 10/613

(52) U.S. Cl. CPC H01M 10/653; H01M 10/613

(57) ABSTRACT

A battery module capable of improving the cooling efficiency between a battery cell and a cooler while ensuring the electrical insulation between the battery cell and the cooler is provided. A battery module according to the present disclosure includes a battery cell, a cooler configured to cool the battery cell, an insulator disposed between the battery cell and the cooler, and a thermal conductor disposed between the battery cell and the cooler. The insulator includes a hollowed part, and the thermal conductor fills the hollowed part. The thermal conductor has an insulating property.

### CROSS REFERENCE TO RELATED APPLICATIONS

This application is based upon and claims the benefit of priority from Japanese patent application No. 2023-131155, filed on Aug. 10, 2023, the disclosure of which is incorporated herein in its entirety by reference.

### BACKGROUND

The present disclosure relates to a battery module.

A battery module disclosed in International Patent Publication No. WO2020/066060 includes a battery cell, an insulating layer, a heat conductive sheet, and a cooling unit. The insulating layer is provided over the entire bottom surface of the battery cell. The heat conductive sheet is in contact with the underside of the insulating layer. The cooling unit cools the entire bottom surface of the battery cell through the insulating layer and the heat conductive sheet.

### SUMMARY

The inventors of the present application have found the following problem.

In such a battery module, heat is transferred from the battery cell to the entire area of the main surface of the heat conductive sheet through the insulating layer. The insulating layer electrically insulates the battery cell from the heat conductive sheet. In many cases, the thermal conductivity of the insulating layer is poorer than that of the heat conductive sheet. Therefore, there is room for improvement of the cooling efficiency between the cooling unit and the battery cell. That is, it is desirable to improve the cooling efficiency between the cooler and the battery cell while ensuring the electrical insulation between the battery cell and the heat conductive sheet.

The present disclosure has been made in view of the above-described problem and provides a battery module capable of improving the cooling efficiency between a battery cell and a cooler while ensuring the electrical insulation between the battery cell and the cooler.

A battery module according to an aspect of the present disclosure includes:
a battery cell;
a cooler configured to cool the battery cell;
an insulator disposed between the battery cell and the cooler; and
a thermal conductor disposed between the battery cell and the cooler, in which
the insulator includes a hollowed part,
the thermal conductor fills the hollowed part, and
the thermal conductor has an insulating property.

Further, in the above-described battery module, the cooler may have such a shape the cooler extends in a lengthwise direction, the hollowed part may include a plurality of hollowed parts arranged so as to be spaced from each other in a crosswise direction intersecting the lengthwise direction, and each of the plurality of hollowed parts may have such a shape that the hollowed part extends in the lengthwise direction, and a space between hollowed parts arranged in the crosswise direction at or near a center in the crosswise direction may be smaller than a space between hollowed parts arranged in the crosswise direction at an end in the crosswise direction.

Further, in the above-described battery module, the cooler may have such a shape the cooler extends in a lengthwise direction,
the hollowed part may include a plurality of hollowed parts arranged so as to be spaced from each other in a crosswise direction intersecting the lengthwise direction, and each of the plurality of hollowed parts may have such a shape that the hollowed part extends in the lengthwise direction, and
an area of a hollowed part disposed at a center in the crosswise direction may be larger than that of a hollowed part disposed at an end in the crosswise direction.

Further, in the above-described battery module, the cooler may have such a shape the cooler extends in a lengthwise direction,
the hollowed part may include a plurality of hollowed parts arranged so as to be spaced from each other in the lengthwise direction, and each of the plurality of hollowed parts may have such a shape that the hollowed part extends in a crosswise direction intersecting the lengthwise direction, and
a space between hollowed parts arranged in the crosswise direction at or near a center in the lengthwise direction may be smaller than a space between hollowed parts arranged in the crosswise direction at an end in the lengthwise direction.

Further, in the above-described battery module, the cooler may have such a shape the cooler extends in a lengthwise direction,
the hollowed part may include a plurality of hollowed parts arranged so as to be spaced from each other in the lengthwise direction, and each of the plurality of hollowed parts may have such a shape that the hollowed part extends in a crosswise direction intersecting the lengthwise direction, and
an area of a hollowed part disposed at a center in the lengthwise direction may be larger than that of a hollowed part disposed at an end in the lengthwise direction.

According to the present disclosure, it is possible to improve the cooling efficiency between a battery cell and a cooler while ensuring the electrical insulation between the battery cell and the cooler.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing a battery module according to a first embodiment;

FIG. 2 is a diagram showing a main part of the battery module according to the first embodiment as viewed in a direction indicated by an arrow II;

FIG. 3 is a cross-sectional view showing a cross section of the battery module taken along a cutting line III-III;

FIG. 4 is a schematic diagram showing a first modified example of an insulator;

FIG. 5 is a schematic diagram showing a second modified example of the insulator;

FIG. 6 is a schematic diagram showing a third modified example of the insulator;

FIG. 7 is a schematic diagram showing a fourth modified example of the insulator; and

FIG. 8 is a schematic diagram showing a fifth modified example of the insulator.

### DESCRIPTION OF EMBODIMENTS

Specific embodiments to which the present disclosure is applied will be described hereinafter in detail with reference to the drawings. However, the present disclosure is not limited to the below-shown embodiments. Further, for clarifying the explanation, the following descriptions and drawings are simplified as appropriate.

### First Embodiment

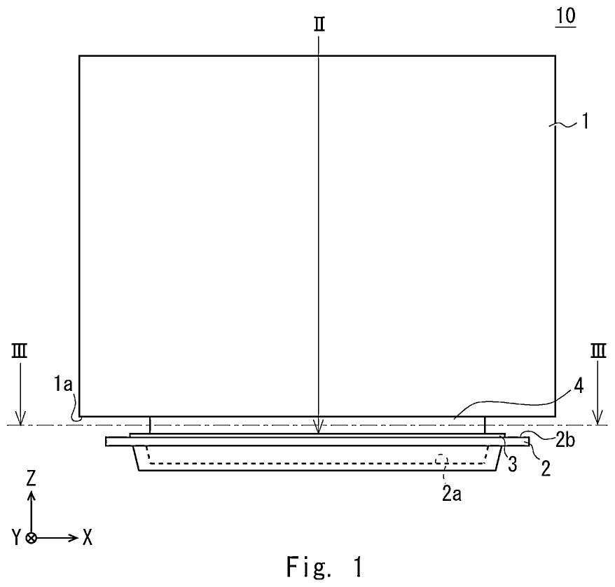

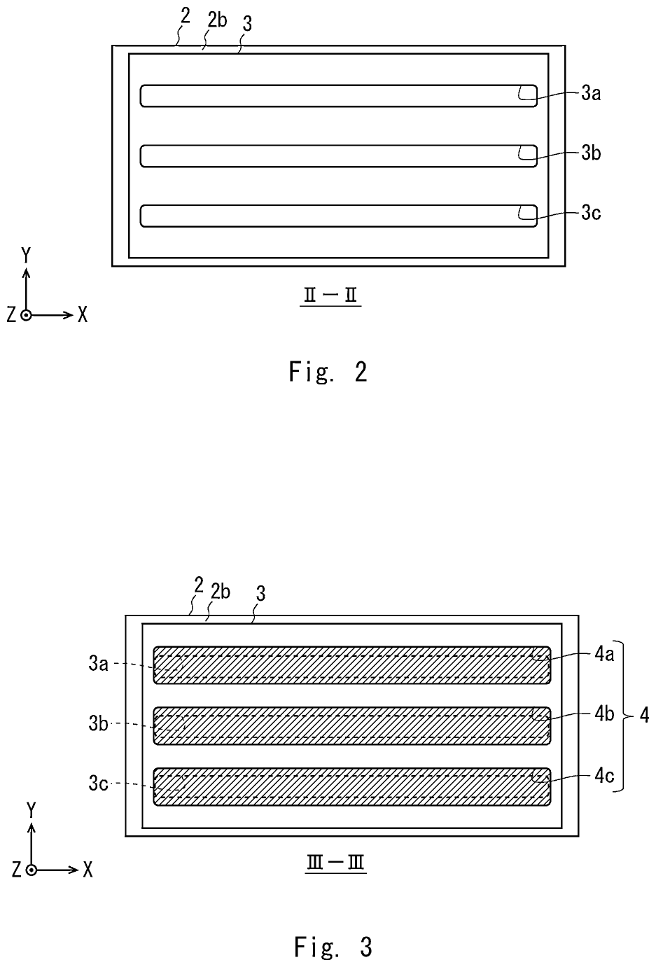

A first embodiment will be described with reference to FIGS. 1 to 3. FIG. 1 is a schematic diagram showing the front of a battery module according to the first embodiment. FIG. 2 is a diagram showing a main part of the battery module shown in FIG. 1 as viewed in a direction indicated by an arrow II. FIG. 3 is a cross-sectional view showing a cross section of the battery module taken along a cutting line III-III shown in FIG. 1.

Note that, needless to say, right-handed XYZ coordinate systems shown in FIG. 1 and other drawings are shown just for explaining the positional relationship among components. In general, a Z-axis positive direction is vertically upward and an XY-plane is a horizontal plane, and they are common in all the drawings.

As shown in FIG. 1, the battery module 10 includes a battery cell 1, a cooler 2, an insulator 3, and a thermal conductor 4.

The battery cell 1 is, for example, a lithium-ion secondary battery, and in particular, may be a solid-state lithium-ion secondary battery. The battery module 10 may include one or a plurality of battery cells 1.

The cooler 2 cools the battery cell 1. An example of the cooler 2 shown in FIG. 1 has a box-like shape. The box-like cooler 2 is made of a metal material and includes a flow path 2a inside thereof. A cooling medium can flow through the flow path 2a. The cooler 2 may have such a shape that the cooler 2 extends in the lengthwise direction (in this example, in the X-axis direction. The cooler 2 may be supplied with a cooling medium as required. The cooler 2 may have an opposed surface 2b opposed to one surface 1a of the battery cell 1 with the insulator 3 and the thermal conductor 4 interposed therebetween.

The insulator 3 is disposed between the battery cell 1 and the cooler 2. The insulator 3 may be in close contact (or direct contact) with the cooler 2. The insulator 3 is made of an insulating material having an electrically insulating property. Examples of the insulating material include polyethylene terephthalate and rubber. An example of the insulator 3 shown in FIGS. 1 to 3 extends in the form of a film or a sheet on the opposed surface 2b of the cooler 2. The insulator 3 may cover substantially the entire area of the opposed surface 2b of the cooler 2. The insulator 3 may be formed by applying an insulating material to the opposed surface 2b. As shown in FIG. 2, the insulator 3 includes hollowed parts 3a, 3b and 3c. Each of the hollowed parts 3a, 3b and 3c has such a shape that the hollowed part extends in the lengthwise direction of the cooler 2 (in this example, in the X-axis direction), and for example, has a substantially rectangular shape. The hollowed parts 3a, 3b and 3c are arranged so as to be spaced from each other in the crosswise direction (in this example, the Y-axis direction) intersecting the lengthwise direction. The hollowed parts 3a, 3b and 3c may penetrate (i.e., extend through) the insulator 3. In other words, the hollowed parts 3a, 3b and 3c may penetrate (i.e., extend) from the surface of the insulator 3 on the side on which the cooler 2 is located to the surface thereof on the side on which the battery cell 1 is located.

The thermal conductor 4 fills the hollowed parts 3a, 3b and 3c of the insulator 3. The thermal conductor 4 is disposed between the battery cell 1 and the cooler 2. The thermal conductor 4 may be in close contact (or direct contact) with the insulator 3 and the one surface 1a of the battery cell 1. An example of the thermal conductor 4 shown in FIG. 3 includes projections 4a 4b, and 4c, which fill the hollowed parts 3a, 3b and 3c, respectively. The projections 4a 4b, and 4c project toward the cooler 2 (in this example, in the Z-axis negative direction) and is in contact or close contact (or direct contact) with the cooler 2. The thermal conductor 4 and the insulator 3 may be compressed by the battery cell 1 and the cooler 2. The thermal conductor 4 preferably thermally couple the battery cell 1 with the cooler 2. The thermal conductor 4 has an insulating property. The thermal conductor 4 is preferably made of, for example, a material having an electrically insulating property and a thermal conductivity. Examples of such a material include silicone, acrylic, and ceramics. The thermal conductor 4 may be formed by applying such a material to the insulator 3. The thermal conductor 4 may have, for example, a sheet-like shape.

As described above, according to the above-described structure of the battery module 10, the insulator 3 and the thermal conductor 4 are disposed between the battery cell 1 and the cooler 2. Each of the insulator 3 and the thermal conductor 4 have an insulating property. As a result, the electrical insulation between the battery cell 1 and the cooler 2 is ensured. Further, the thermal conductor 4 fills the hollowed parts 3a, 3b and 3c of the insulator 3 and is in contact with the cooler 2. As a result, the thermal conductivity between the battery cell 1 and the cooler 2 is improved. Consequently, the cooling efficiency between the battery cell 1 and the cooler 2 can be improved.

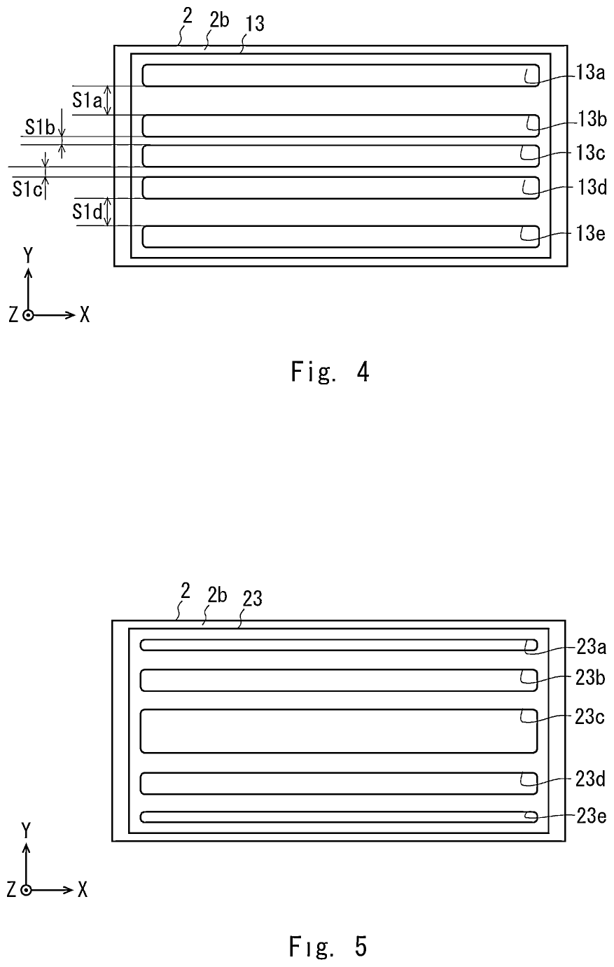

Next, various modified examples of the battery module 10 will be described with reference to FIGS. 4 to 8. Each of the various modified examples of the battery module 10 has the same structure as that of the battery module 10 shown in FIG. 1, except for its insulator. Each of FIGS. 4 to 8 shows a modified example of the insulator 3 shown in FIG. 2. Note that the thermal conductor 4 of each of the modified examples of the battery module 10 has a shape conforming to the insulator of that modified example.

### First Modified Example

A first modified example of the battery module 10 includes an insulator 13 shown in FIG. 4. The insulator 13 includes hollowed parts 13a, 13b, 13c, 13d and 13e. The hollowed parts 13a, 13b, 13c, 13d and 13e are arranged so as to be spaced from each other in the crosswise direction of the cooler 2 (in this example, the Y-axis direction) intersecting the lengthwise direction thereof. Each of the hollowed parts 13a, 13b, 13c, 13d and 13e has such a shape that the hollowed part extends in the lengthwise direction, and for example, has a substantially rectangular shape. The hollowed parts 13a, 13b, 13c, 13d and 13e may have widths and areas substantially equal to each other.

The hollowed parts 13a, 13b, 13c, 13d and 13e are arranged in this order in the crosswise direction. The hollowed part 13c is disposed at the center in the crosswise direction. The hollowed parts 13a and 13e are disposed at the ends in the crosswise direction. The hollowed parts 13b, 13c and 13d are arranged at or near the center in the crosswise direction. The hollowed parts 13a and 13b are arranged at an end in the crosswise direction. The hollowed parts 13d and 13e are arranged at an end in the crosswise direction.

A space between neighboring two of the hollowed parts 13b, 13c and 13d arranged at or near the center in the crosswise direction is smaller than a space between neighboring two of the hollowed parts 13a, 13b, 13d and 13e arranged at the ends in the crosswise direction. Specifically, a space S1b between the hollowed parts 13b and 13c is smaller than a space S1a between the hollowed parts 13a and 13b. A space S1c between the hollowed parts 13c and 13d is smaller than a space S1d between the hollowed parts 13d and 13e. A space S1b is smaller than a space S1d. A space S1c is smaller than a space S1a.

As described above, according to the structure of the first modified example of the battery module 10, a space between neighboring two of the hollowed parts 13b, 13c and 13d arranged at or near the center in the crosswise direction is smaller than a space between neighboring two of the hollowed parts 13a, 13b, 13d and 13e arranged at the ends in the crosswise direction. Therefore, in the insulator 13, the density of hollowed parts at or near the center in the crosswise direction is higher than that at the ends in the crosswise direction. Further, the thermal conductor 4 (not shown) fills the hollowed parts 13a to 13e of the insulator 13 and is in contact with the cooler 2. Therefore, the cooling efficiency can be further improved at or near the center in the crosswise direction. Heat is more likely to be concentrated in the area at or near the center of the one surface 1a of the battery module 10 shown in FIG. 1 than in the ends thereof, so that the battery cell 1 can be suitably cooled.

### Second Modified Example

A second modified example of the battery module 10 includes an insulator 23 shown in FIG. 5. The insulator 23 includes hollowed parts 23a, 23b, 23c, 23d and 23e. The hollowed parts 23a, 23b, 23c, 23d and 23e are arranged so as to be spaced from each other in the crosswise direction of the cooler 2 (in this example, the Y-axis direction) intersecting the lengthwise direction thereof. The hollowed parts 23a, 23b, 23c, 23d and 23e may be roughly equally spaced from each other. Each of the hollowed parts 23a, 23b, 23c, 23d and 23e has such a shape that the hollowed part extends in the lengthwise direction, and for example, has a substantially rectangular shape.

The hollowed parts 23a, 23b, 23c, 23d and 23e are arranged in this order in the crosswise direction. The hollowed part 23c is arranged at the center in the crosswise direction. The hollowed parts 23a and 23e are disposed at the ends in the crosswise direction.

The area of the hollowed part 23c disposed at the center in the crosswise direction is larger than that of each of the hollowed parts 23a and 23e disposed at the ends in the crosswise direction. Further, it is preferable that the areas of the hollowed parts 23a, 23b, 23c, 23d and 23e become larger as the position of the hollowed part is closer to the center and farther from the end in the crosswise direction. Specifically, the areas of the hollowed parts 23c, 23b and 23a are preferably, in descending order, in this order, i.e., the order of the hollowed parts 23c, 23b and 23a. The areas of the hollowed parts 23c, 23d and 23e are preferably, in descending order, in this order, i.e., the order of the hollowed parts 23c, 23d and 23e.

As described above, according to the structure of the second modified example of the battery module 10, in the insulator 13, the area of the hollowed part 23c disposed at the center in the crosswise direction is larger than that of each of the hollowed parts 23a and 23e disposed at the ends in the crosswise direction. Further, the thermal conductor 4 (not shown) fills the hollowed parts 23a to 23e of the insulator 23 and is in contact with the cooler 2. Therefore, the cooling efficiency can be further improved at or near the center in the crosswise direction. Heat is more likely to be concentrated in the area at or near the center of the one surface 1a of the battery module 10 shown in FIG. 1 than in the ends thereof, so that the battery cell 1 can be suitably cooled.

### Third Modified Example

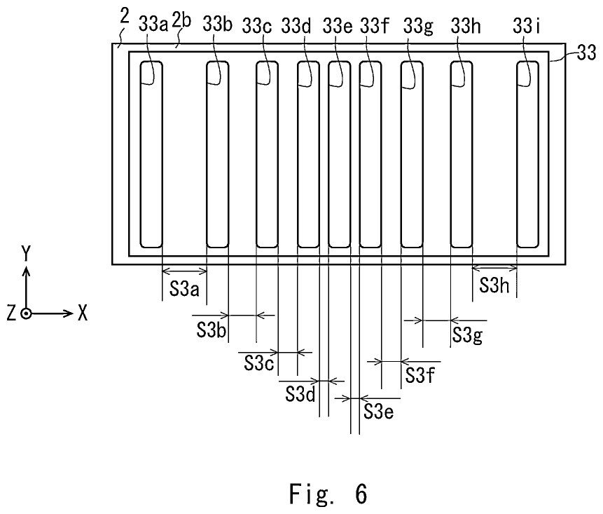

A third modified example of the battery module 10 has the same structure as that of the first modified example of the battery module 10, except for the direction in which the hollowed parts extend and the direction in which the hollowed parts are arranged. The third modified example of the battery module includes an insulator 33 shown in FIG. 6. The insulator 33 includes hollowed parts 33a, 33b, 33c, 33d, 33e, 33f, 33g, 33h and 33i. The hollowed parts 33a to 33i are arranged so as to be spaced from each other in the lengthwise direction of the cooler 2 (in this example, the X-axis direction). Each of the hollowed parts 33a to 33i has such a shape that the hollowed part extends in the lengthwise direction, and for example, has a substantially rectangular shape. The hollowed parts 33a to 33i may have widths and areas substantially equal to each other.

The hollowed parts 33a to 33i are arranged in this order in the lengthwise direction. The hollowed part 33e is disposed at the center in the lengthwise direction. The hollowed parts 33a and 33i are disposed at the ends in the lengthwise direction. The hollowed parts 33d, 33e and 33f are arranged at or near the center in the lengthwise direction. The hollowed parts 33a and 33b are arranged at an end in the lengthwise direction. The hollowed parts 33h and 33i are arranged at an end in the lengthwise direction.

A space between neighboring two of the hollowed parts 33d, 33e and 33f arranged at or near the center in the lengthwise direction is smaller than a space between neighboring two of the hollowed parts 33a, 33b, 33h and 33i arranged at the ends in the lengthwise direction. Specifically, a space S3d between the hollowed parts 33d and 33e is smaller than a space S3a between the hollowed parts 33a and 33b. A space S3e between the hollowed parts 33e and 33f is smaller than a space S3h between the hollowed parts 33h and 33i. A space S3d is smaller than a space S3h. A space S3e is smaller than a space S3a.

Further, it is preferable that the spaces between the hollowed parts 33a to 33i become larger as the position of the space is closer to the end and farther from the center in the lengthwise direction. Specifically, the space S3a, the space S3b between the hollowed parts 33b and 33c, the space S3c between the hollowed parts 33c and 33d, and the space S3d are preferably, in descending order, in this order, i.e., in the order of the spaces S3a, S3b, S3c and S3d. The space S3h, the space S3g between the hollowed parts 33g and 33h, the space S3f between the hollowed parts 33f and 33g, and the space S3e are preferably, in descending order, in this order, i.e., in the order of the spaces S3h, S3g, S3f and S3e.

As described above, according to the structure of the third modified example of the battery module 10, a space between neighboring two of the hollowed parts 33d, 33e and 33f arranged at or near the center in the lengthwise direction is smaller than a space between neighboring two of the hollowed parts 33a, 33b, 33h and 33i arranged at the ends in the lengthwise direction. Therefore, in the insulator 33, the density of hollowed parts at or near the center in the lengthwise direction is higher than that at the edges in the lengthwise direction. Further, the thermal conductor 4 (not shown) fills the hollowed parts 33a to 33i of the insulator 33 and is in contact with the cooler 2. Therefore, the cooling efficiency can be further improved at or near the center the lengthwise direction. Heat is more likely to be concentrated in the area at or near the center of the one surface 1a of the battery module 10 than in the ends thereof, so that the battery cell 1 can be suitably cooled.

### Fourth Modified Example

A fourth modified example of the battery module 10 has the same structure as that of the second modified example of the battery module 10, except for the direction in which the hollowed parts extend and the direction in which the hollowed parts are arranged. The fourth modified example of the battery module includes an insulator 43 shown in FIG. 7. The insulator 43 includes hollowed parts 43a, 43b, 43c, 43d, 43e, 43f, 43g, 43h and 43i. The hollowed parts 43a to 43i are arranged so as to be spaced from each other in the lengthwise direction of the cooler 2 (in this example, the X-axis direction). The hollowed parts 43a to 43i may be roughly equally spaced from each other. Each of the hollowed parts 43a to 43i has such a shape that the hollowed part extends in the crosswise direction, and for example, has a substantially rectangular shape.

The hollowed parts 43a to 43i are arranged in this order in the lengthwise direction. The hollowed part 43e is disposed at the center in the lengthwise direction. The hollowed parts 43a and 43i are disposed at the ends in the lengthwise direction.

The area of the hollowed part 43e disposed at the center in the lengthwise direction is larger than that of each of the hollowed parts 43a and 43i disposed at the ends in the lengthwise direction. Further, it is preferable that the areas of the hollowed parts 43a to 43i become larger as the position of the hollowed part is closer to the center and farther from the end in the lengthwise direction. Specifically, the areas of the hollowed parts 43e, 43d, 43c, 43b and 43a are, in descending order, in this order, i.e., the order of the hollowed parts 43e, 43d, 43c, 43b and 43a. The areas of the hollowed parts 43e, 43f, 43g, 43h and 43i are, in descending order, in this order, i.e., the order of the hollowed parts 43e, 43f, 43g, 43h and 43i.

As described above, according to the structure of the fourth modified example of the battery module 10, in the insulator 43, the area of the hollowed part 43e disposed at the center in the lengthwise direction is larger than that of each of the hollowed parts 43a and 43i disposed at the ends in the lengthwise direction. Further, the thermal conductor 4 (not shown) fills the hollowed part 43a to 23i of the insulator 43 and is in contact with the cooler 2. Therefore, the cooling efficiency can be further improved at or near the center the lengthwise direction. Heat is more likely to be concentrated in the area at or near the center of the one surface 1a of the battery module 10 than in the ends thereof, so that the battery cell 1 can be suitably cooled.

### Fifth Modified Example

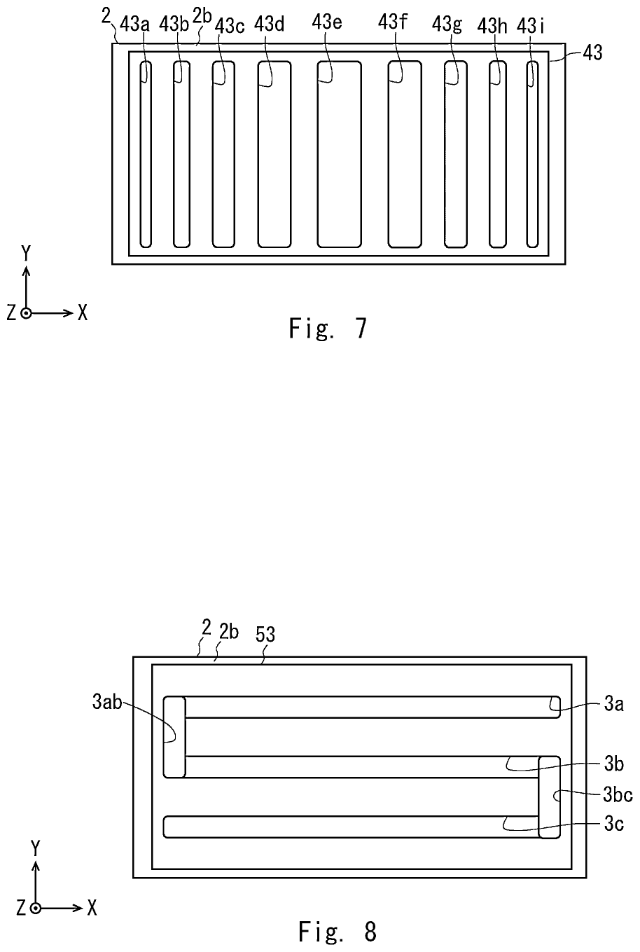

A fifth modified example of the battery module 10 includes an insulator 53 shown in FIG. 8. The insulator 53 includes hollowed parts 3ab and 3bc. Hollowed parts 3a, 3b, 3c, 3ab and 3bc are continuous and extend along one line. The hollowed part 3ab connects the hollowed part 3a with the hollowed part 3b. The hollowed part 3bc connects the hollowed part 3b with the hollowed part 3c.

Specifically, the hollowed part 3ab extends from one end of the hollowed part 3a to one end of the hollowed part 3b, and thereby connects the one end of hollowed part 3a with the one end of hollowed part 3b. The hollowed part 3ab extends from the one end of the hollowed part 3a in the crosswise direction of the cooler 2 (in this example, the Y-axis direction). The hollowed part 3bc extends from the other end of the hollowed part 3b to the other end of the hollowed part 3c, and thereby connects the other end of the hollowed part 3b with the other end of the hollowed part 3c. The hollowed part 3bc extends from the other end of the hollowed part 3b in the crosswise direction of the cooler 2.

Aa described above, in the above-described fifth modified example of the battery module 10, similarly to the battery module 10 shown in FIG. 1, it is also possible to improve the cooling efficiency between the battery cell 1 and the cooler 2 while ensuring the electrical insulation between the battery cell 1 and the cooler 2.

Note that the present disclosure is not limited to the above-described embodiments, and they can be modified as appropriate without departing from the scope and spirit of the disclosure. Further, the present disclosure may also be implemented by combining two or more of the above-described embodiments and their examples as desired. For example, the thermal conductor 4, the insulator 3, and the cooler 2 may be disposed on a surface other than the one surface 1a of the battery cell 1. In other words, the battery module 10 may have a plurality of surfaces on which the thermal conductor 4, the insulator 3, and the cooler 2 are disposed. The number of hollowed parts is not limited to any particular number, and may be any number equal to or greater than one. In other words, while the battery module 10 includes the hollowed parts 3a, 3b and 3c, it may have any number of hollowed parts equal to or greater than one. Similarly, each of the other modified examples of the battery module 10 may have any number of hollowed parts equal to or greater than one.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery module comprising:
a battery cell;
a cooler configured to cool the battery cell;
an insulator disposed between the battery cell and the cooler; and
a thermal conductor disposed between the battery cell and the cooler, wherein
the insulator includes a hollowed part,
the thermal conductor fills the hollowed part, and
the thermal conductor has an insulating property.

2. The battery module according to claim 1, wherein
the cooler has such a shape that the cooler extends in a lengthwise direction,
the hollowed part includes a plurality of hollowed parts arranged so as to be spaced from each other in a crosswise direction intersecting the lengthwise direction, and each of the plurality of hollowed parts has such a shape that the hollowed part extends in the lengthwise direction, and
a space between hollowed parts arranged in the crosswise direction at or near a center in the crosswise direction is smaller than a space between hollowed parts arranged in the crosswise direction at an end in the crosswise direction.

3. The battery module according to claim 1, wherein
the cooler has such a shape that the cooler extends in a lengthwise direction,
the hollowed part includes a plurality of hollowed parts arranged so as to be spaced from each other in a crosswise direction intersecting the lengthwise direction, and each of the plurality of hollowed parts has such a shape that the hollowed part extends in the lengthwise direction, and
an area of a hollowed part disposed at a center in the crosswise direction is larger than that of a hollowed part disposed at an end in the crosswise direction.

4. The battery module according to claim 1, wherein
the cooler has such a shape that the cooler extends in a lengthwise direction, the hollowed part includes a plurality of hollowed parts arranged so as to be spaced from each other in the lengthwise direction, and each of the plurality of hollowed parts has such a shape that the hollowed part extends in a crosswise direction intersecting the lengthwise direction, and
a space between hollowed parts arranged in the crosswise direction at or near a center in the lengthwise direction is smaller than a space between hollowed parts arranged in the crosswise direction at an end in the lengthwise direction.

5. The battery module according to claim 1, wherein
the cooler has such a shape that the cooler extends in a lengthwise direction,
the hollowed part includes a plurality of hollowed parts arranged so as to be spaced from each other in the lengthwise direction, and each of the plurality of hollowed parts has such a shape that the hollowed part extends in a crosswise direction intersecting the lengthwise direction, and
an area of a hollowed part disposed at a center in the lengthwise direction is larger than that of a hollowed part disposed at an end in the lengthwise direction.
